(19) United States
(12) Patent Application Publication
(10) Pub. No.: US 2007/0242842 A1
(43) Pub. Date: Oct. 18, 2007

(54) Method of Manufacturing Film-Speaker Using Piezoelectric Film and Sound Equipment with the Same

(75) Inventor: Chul Ung Kim, Seoul (KR)

Correspondence Address: VENABLE LLP, P.O. BOX 34385, WASHINGTON, DC, 20043-9998, US

(73) Assignee: Mirae Plasma Co., Ltd., Seoul (KR)

(21) Appl. No.: 10/591,168

(22) PCT Filed: Mar. 4, 2005
(86) PCT No.: PCT/KR05/00599

§ 371 Date: Jun. 18, 2007

(30) Foreign Application Priority Data
Mar. 4, 2004 (KR) 10-2004-0014782
Sep. 7, 2004 (KR) 10-2004-0071387
Nov. 11, 2004 (KR) 10-2004-0092161

(51) Int. Cl. H04R 7/00

(52) U.S. Cl. 381/190

(57) ABSTRACT

A method of manufacturing a film-speaker using a piezoelectric material and a sound equipment with the film-speaker are disclosed. A sound equipment with a film-speaker comprises a film-speaker unit, a matching transformer connected with the film-speaker unit, an amplifier coupled with the matching transformer, and a power supply unit providing the amplifier with power The film-speaker unit includes a piezoelectric film and electrodes formed on both surfaces of the piezoelectric film. The surface of the piezoelectric film are reformed by irradiating ions with a predetermined energy under a vacuum state to increase an adhesive force. The electrodes are formed by depositing conductive material on both surfaces of the piezoelectric film. The sound equipment with a film-speaker further includes a condenser positioned between the film-speaker unit and the matching transformer, a dynamic speaker installed between the amplifier and the matching transformer, and a coil positioned between the amplifier and the dynamic speaker

### TECHNICAL FIELD

The present invention relates to a method of manufacturing a film-speaker using a piezoelectric material and a sound equipment comprising the film-speaker, and, more particularly, a method manufacturing a thin film-speaker by increasing surface adhesive force of a thin piezoelectric film and a sound equipment comprising the thin film-speaker alone or both thin film-speaker and general loudspeaker.

### BACKGROUND ART

A speaker is a device to generate a sound and has a variety of uses because it has to be necessarily employed to make a sound. Namely, the speaker is a necessary component used in every electronics from a toy to a telecommunication equipment as well as an audio equipment, a broadcasting equipment installed within a building or facilities, a television set, a radio set, and a telephone.

A conventional speaker includes a circularly wound coil and a permanent magnet. When an electric current is applied to the circularly wound coil, induced electromotive force is generated between the coil wound and the permanent magnet. The induced electromotive force causes trembling of a diaphragm attached to the permanent magnet, thereby vibrating air to make a sound. Such a conventional speaker generally occupies a large space becasue its large size, particularly its thickness, due to the coil and permanent magnet. Moreover, the conventional speaker for a sound system has a fixed shape of a cube or cylinder type and is relatively heavy in weight. Therefore, the conventional speaker is limited in design and inconvenient in carrying along. In addition, it is difficult to manufacture a portable speaker for a portable sound source such as an MP3 player or CD player because the conventional speaker is mainly operated by electricity.

Recently, a paper-like thin film-speaker has been developed and come into widespread use being integrated with a variety of fields. A film-speaker is a speaker device comprising a polymer film with a piezoelectric characteristic on both surfaces of which conductive material is deposited to form electrodes. A conventional speaker using ceramic material is manufactured through several steps of production processes. However, the film-speaker is readily made by changing the surface of a piezoelectric polymer film into the surface with a hydrophilic property at room temperature and forming an electrode layer thereon without performing complicated forming processes.

Generally, metal or conductive material cannot be adhered to the surface of a polymer film with a piezoelectric property which has a smooth surface. Accordingly, electrode layers has to be formed on the polymer film after both surfaces of the polymer film are harshened by a reforming technology using plasma.

In view of sound, a conventional dynamic speaker is less powerful in a high-pitched tone and,thus, tends to convey distortedly the sound of string instruments or voice. On the contrary, the film-speaker is excellent in a high-pitched tone and less powerful in a low-pitched tone. Therefore, a user may feel tired in listening the sound from the film speaker for a long time. Moreover, the film-speaker has to employ an adaptor(direct current power device) because it requires a large amount of voltage.

### DISCLOSURE OF INVENTION

Technical Problem

Accordingly, the present invention is directed to a method of manufacturing a film-speaker using a piezoelectric film and sound equipment with the same that substantially obviate one or more problems due to limitations and disadvantages of the related art.

An object of the present invention is to provide a method of enhancing the adhesive property of the surface of a piezoelectric film in fabricating a film-speaker unit.

Another object of the present invention is to provide a sound equipment having a film-speaker, which outputs the sound from the sound equipment through the film-speaker by combining an amplifier with a film-speaker unit.

Another object of the present invention is to provide a sound equipment comprising a film-speaker, which is capable of producing accurately wide-range frequencies by combining a excellent high frequency performance of a film speaker and powerful reproduction in middle and low registers of a dynamic speaker.

Technical Solution

In fabricating a film-speaker, electrode material cannot be readily deposited on the surface of a piezoelectric film. A method of improving an adhesive force of the surface of the piezoelectric film is to make the surface harsh or to change the chemical structure of the surface by irradiating ions with a predetermined energy level to the piezoelectric film in a vacuum state. Then, electrode material is deposited on the reformed surface of the piezoelectric film by using a known coating technology such as dip coating, spin coating, spray coating, silk screen, vacuum deposition, or roll-to-roll coating. Such a structure that electrodes are formed on both surfaces of the piezoelectric film is referred to as a film-speaker unit. The film-speaker unit is connected with a transformer, an amplifier, and a power supply to construct a sound equipment with a film-speaker. When an electric signal is applied to the film-speaker, the piezoelectric film vibrates more than tens of thousands times in a second to change the electric signal into sound.

In another embodiment, by combining the film-speaker and a conventional dynamic speaker, a new sound equipment to compensate for disadvantages of each speaker can be constructed. In detail, the new sound equipment with a film-speaker and a dynamic speaker comprises a condenser filtering a low register, which is coupled with the film-speaker unit; a coil filtering a high register, which is coupled with the dynamic speaker; and a transformer and an amplifier amplifying sound pressure, which are connected with the condenser and coil.

The sound equipment having the film-speaker has a semipermanent life span and is applicable to various fields of industry, for example, illumination, interior, fancy industry, equipment for the military such as a sonar detector for the navy, etc.

### BRIEF DESCRIPTION OF THE DRAWINGS

FIG. 1 is a diagram describing a method of surface reforming treatment to a piezoelectric film in accordance with the present invention.

FIG. 2 is a perspective view illustrating a film-speaker unit in accordance with the present invention.

FIG. 3 is a perspective view illustrating a film-speaker unit comprising metal lead lines in accordance with the present invention.

FIG. 4 is a schematic diagram illustrating a sound equipment having a film speaker in accordance with the present invention.

FIG. 5 is a schematic diagram illustrating a sound equipment comprising a film speaker and a dynamic speaker in accordance with the present invention.

### BEST MODE FOR CARRYING OUT THE INVENTION

Further objects and advantages of the invention can be more fully understood from the following detailed description taken in conjunction with the accompanying drawings.

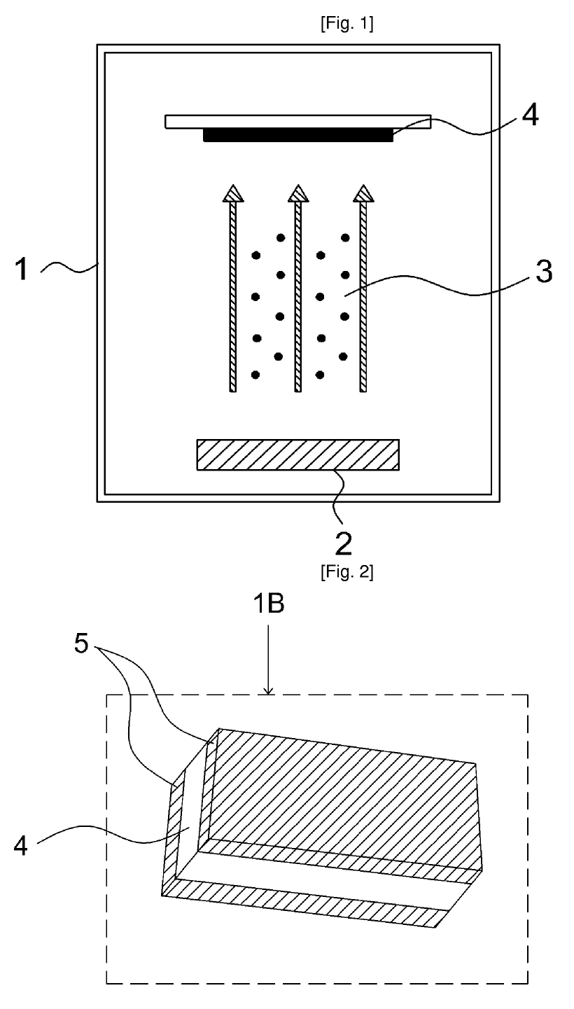

FIG. 1 is a drawing illustrating a method of surface reforming treatment to a piezoelectric film. To manufacture a film-speaker, conductive material has to be deposited on both surfaces of the piezoelectric film to form electrodes. The surface of the piezoelectric film has to be harshened through a surface reforming process using particles such as ions in order to help the conductive material to be easily deposited on the smooth surface of an ordinary piezoelectric film.

Referring to FIG. 1, a piezoelectric film (4) is first positioned in a vacuum chamber (1). The piezoelectric film may be selected from a group consisting of piezoelectric polymer such as polyvinylidenfluoride (hereinafter referred to as “PVDF”) and derivatives thereof, polymer blends including an additive such as HFP, and vinylidenefluoride/trifluoroethylene (hereinafter referred to as “VDF/TrFF). Then, ions (3) at a predetermined energy level, which is generated from an ion source (2), are irradiated on the surface of the piezoelectric film under the vacuum state. Here, the ions may be selected from a group consisting of oxygen, argon, nitrogen, hydrogen, mixtures including oxygen, argon, nitrogen or hydrogen, and other mixture gases. The energy range of the irradiated ions is between about 0.2 keV and about 1.5 keV. The current density of ion beam is between about 0.01 mA/□ and about 100 mA/□. The degree of vacuum ranges from about 0.05 mTorr to about 10 mTorr. The distance between the piezoelectric film and the ion generation point is preferably between about 1 □ and about 50 □. Under the above-described conditions, the ions are irradiated on the surface of the piezoelectric film to reform the surface of the piezoelectric film by reducing a contact angle of the surface of the piezoelectric film or increasing adhesive force of the surface of the piezoelectric film.

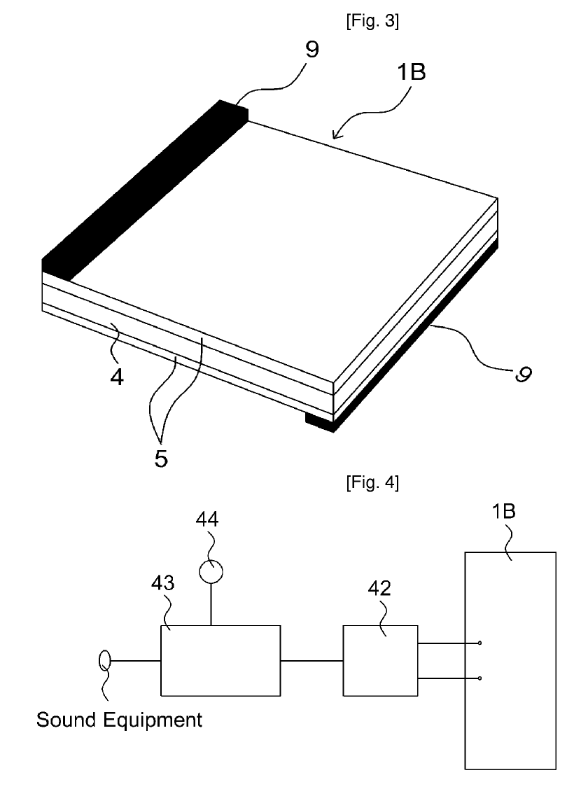

FIG. 2 is a perspective view illustrating a film speaker unit in accordance with the present invention. FIG. 3 is a perspective view illustrating a film speaker unit including metal lead lines in accordance with the present invention.

Referring to FIGS. 2 and 3, a conductive material is deposited on both surfaces of the piezoelectric film to form electrodes (5) with increased adhesive force. The conductive material is coated by using a known coating technology such as dip coating, spin coating, spray coating, silk screen, vacuum deposition, or roll-to-roll method. The conductive material for forming electrodes may be selected from a group consisting of platinum, gold, silver, copper, chromium, nickel, aluminium, indium-tin-oxide (hereinafter referred to as “ITO”), IGO, AGO, sulphur compounds, or mixtures thereof. The electrodes (5) may be made from a mixture including the above-described conductive material or mixture and a specific solution or material which can increase conductivity and adhesive property.

In another embodiment, the electrodes (5) may be formed of a conducting polymer instead of metal. Here, when the electrodes (5) are made from conducting polymer material, as shown in FIG. 3, a metal lead line (9) has to be formed on one side of each electrode (5) so that electric signal can be efficiently transferred to the electrode (5). By performing the above-described processes, a film-speaker unit (1B) comprising the piezoelectric film (4) and electrodes (5) formed on both surfaces of the piezoelectric film (4), is completed.

FIG. 4 is a schematic diagram illustrating a sound equipment with a film-speaker in accordance with the present invention. Referring to FIG. 4, a transformer (42) to amplify voltage is connected to a film speaker unit (1B). The transformer (42) is coupled with an amplifier (43) and the amplifier (43) is connected with a sound equipment. The electric signal from the source equipment is amplified into a pre-determined level by the amplifier (43). The amplifier (43) is connected with a power supply unit (44) such as a battery or adaptor providing operation power. In the sound equipment with the film speaker according to the present invention, an audio signal generated from the source equipment is amplified into a predetermined level through the amplifier (43). The amplified audio signal is amplified into a predetermined voltage through the matching transformer (42) and, then, is applied to the film-speaker unit (1B) comprising a piezoelectric film and electrodes. Accordingly, the piezoelectric film of the film-speaker unit (1B) vibrates to generate a sound. In other words, the film-speaker generates a sound when the piezoelectric film finely vibrates tens of thousands times in a second by the electric current evenly transferred to the piezoelectric film. Additionally, the film-speaker unit (1B) including a piezoelectric film according to the present invention may be used as a synthesizer because it is very flexible and can control the pitch and tempo of sound based on the degree of flexibility.

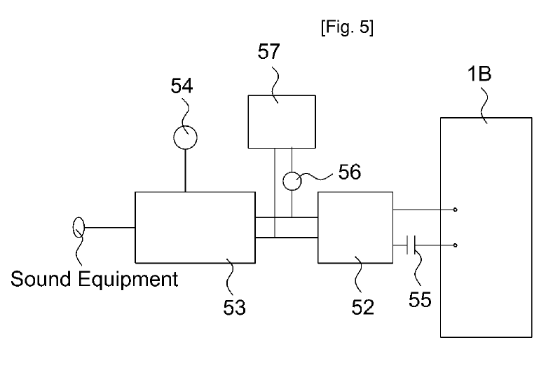

FIG. 5 is a schematic diagram illustrating a sound equipment comprising a film speaker and a dynamic speaker in accordance with the present invention. Referring to FIG. 5, in addition to the structure of a sound equipment of FIG. 4, which comprises a film-speaker unit (1B), a matching transformer (52), an amplifier (53), and a power supply unit (54), a condenser (55) to filter a low register is connected between the film-speaker unit (1B) and the matching transformer (52). Then, a dynamic speaker (57) for middle and low pitched tones is positioned between the amplifier (53) and the matching transformer (52). A coil (56) to filter the high register of the dynamic speaker (57) is installed between the dynamic speaker (57) and the amplifier (53).

Accordingly, by combining the film-speaker with the dynamic speaker, the sound from all kinds of portable sound systems can be publicly shared through the film-speaker and the dynamic speaker to and from anywhere and any time. Particularly, the film-speaker according to the present invention is widely applicable to a language teaching field because the film-speaker has an excellent performance in middle and high registers compared to an existing dynamic speaker.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

### INDUSTRIAL APPLICABILITY

Accordingly, by using a sound equipment with a film-speaker in accordance with the present invention, an abnormal symptom in the hearing ability due to overuse of earphones for a sound system can be prevented, and the sound from various portable sound systems such as an MP3 player can be shared by people to and from anywhere and any time.

The film-speaker has excellent performance in middle and high frequencies, thereby being extensively applicable to a language teaching field. From the nature of the film-speaker, it generates all the sound range from a low-pitched tone to a high-pitched tone according to the degree of flexure. Thus, the film-speaker can be used in various industry fields.

In addition, various colored designs and patterns can be printed on the electrodes of the film-speaker. Thus, by integrating the film-speaker with a conventional visual advertisement, the conventional visual advertisement such as a poster, a leaflet, a letter paper, a book, a framed advertising display, a hanging placard, a banner, etc., can be made into an audiovisual advertisement which the ears can hear as well as the eyes can see. Therefore, it is possible to manufacture multimedia advertisements with high effectiveness of advertising. Moreover, by applying the film-speaker to blinds, lighting apparatus, or interior articles, etc., a ubiquitous home sound system without speakers can be achieved.

1. A sound equipment with a film-speaker comprising:
a film-speaker unit comprising a piezoelectric film and electrodes formed on both surfaces of the piezoelectric film, wherein both surfaces of the piezoelectric film are reformed by performing a surface treatment using ions with a predetermined energy under a vacuum state to increase an adhesive force, and the electrodes are formed by depositing conductive material on both surfaces of the piezoelectric film;
a matching transformer connected with the film-speaker unit;
an amplifier connected to the matching transformer; and
a power supply unit providing the amplifier with power.

2. The sound equipment as defined by claim 1, wherein the piezoelectric film is selected from a group consisting of PVDF and derivatives thereof, polymer blends including an additive such as HFP, and VDF/TrFE.

3. The sound equipment as defined by claim 1, wherein the surface treatment to increase an adhesive force comprises the steps of:
positioning the piezoelectric film under a vacuum state, wherein the degree of vacuum ranges from about 0.05 mTorr to about 10 mTorr; and
irradiating ions on the piezoelectric film, wherein the ions have an energy level between about 0.2 keV and about 1.5 keV and a current density of ion beam is between about 0.01 mA/□ and about 100 mA/□.

4. The sound equipment as defined by claim 3, wherein the ions are selected from a group consisting of oxygen, argon, nitrogen, hydrogen, mixtures including oxygen, argon, nitrogen or hydrogen, and other mixture gases.

5. The sound equipment as defined by claim 3, wherein the piezoelectric film is positioned at a distance of 1 cm-50 cm from a ion generation point.

6. The sound equipment as defined by claim 1, wherein the conductive material to form the electrodes is selected from a group consisting of platinum, gold, silver, copper, chromium, nickel, aluminium, ITO, IGO, AGO, sulphur compounds, mixtures including platinum, gold, silver, copper, chromium, nickel, aluminium, ITO, IGO, AGO or sulphur compounds, and a mixture including the above-described conductive material or mixture and a specific solution or material which can increase conductivity and adhesive property.

7. The sound equipment as defined by claim 1, wherein the conductive material to form the electrodes is a conductive polymer material.

8. The sound equipment as defined by claim 7, wherein the electrodes made from the conductive polymer material further comprises a metal lead line formed on one side of the surface of each electrode.

9. The sound equipment as defined by claim 1, further comprising:
a condenser positioned between the film-speaker unit and the matching transformer, the condenser filtering a low register;
a dynamic speaker installed between the amplifier and the matching transformer; and
a coil positioned between the amplifier and the dynamic speaker, the coil filtering a high register.
